(19) United States
(12) Patent Application Publication
(10) Pub. No.: US 2024/0094955 A1
(43) Pub. Date: Mar. 21, 2024

(54) MEMORY SYSTEM

(71) Applicant: Kioxia Corporation, Tokyo (JP)

(72) Inventor: Shinichi MATSUKAWA, Shinagawa Tokyo (JP)

(21) Appl. No.: 18/458,755

(22) Filed: Aug. 30, 2023

(30) Foreign Application Priority Data
Sep. 15, 2022 (JP) 2022-147310

(51) Int. Cl. G06F 3/06

(52) U.S. Cl. CPC G06F 3/0659; G06F 3/0614; G06F 3/0679

(57) ABSTRACT

A memory system includes a non-volatile memory and a memory controller. The memory controller is configured to perform write, read, and erase operations in accordance with write commands, read commands, and erase commands, respectively, from a host, and receive, from the host, time information indicating times when the write, read, and erase commands have been transmitted from or issued by the host. The memory controller is further configured to generate, from the received time information, history data including a value representing a busy state of the memory system with respect to each time range in a predetermined time period, and perform a maintenance operation with respect to the non-volatile memory upon time at which a command received from the host has been transmitted from or issued by the host falling in one or more of the time ranges corresponding to values smaller than the other of the time ranges.

### CROSS-REFERENCE TO RELATED APPLICATION(S)

This application is based upon and claims the benefit of priority from Japanese Patent Application No. 2022-147310, filed Sep. 15, 2022, the entire contents of which are incorporated herein by reference.

### FIELD

Embodiments described herein relate generally to a memory system including a non-volatile memory.

### BACKGROUND

Memory systems including a non-volatile memory are widely used. A solid-state drive (SSD) including a NAND flash memory is known as one kind of such a memory system.

A non-volatile memory maintenance process such as a garbage collection (or compaction), a refresh, or a patrol read is carried out in the aforementioned memory system. A maintenance process is usually executed when the memory system turns to an on-state, or in accordance with a command from a host device. It is desirable to execute the aforementioned maintenance process without affecting a performance of the memory system.

### BRIEF DESCRIPTION OF THE DRAWINGS

FIG. 1 is a block diagram showing a configuration of a memory system according to an embodiment.

FIG. 2 is a functional block diagram of a memory system according to an embodiment.

FIG. 3 is a flowchart relating to histogram generation in a memory system according to an embodiment.

FIG. 4 is a drawing showing an example of a histogram used in a memory system according to an embodiment.

FIG. 5 is a flowchart relating to a maintenance process execution in a memory system according to an embodiment.

FIG. 6 is a functional block diagram of a memory system according to an embodiment.

FIG. 7 is a flowchart relating to histogram generation in a memory system according to an embodiment.

FIG. 8 is a functional block diagram of a memory system according to an embodiment.

FIG. 9 is a flowchart relating to histogram generation in a memory system according to an embodiment.

FIG. 10 is a flowchart relating to a maintenance process execution in a memory system according to an embodiment.

### DETAILED DESCRIPTION

Embodiments provide an execution of a maintenance process without affecting a performance of a memory system.

In general, according to an embodiment, a memory system includes a non-volatile memory and a memory controller. The memory controller is configured to perform write operations, read operations, and erase operations with respect to the non-volatile memory in accordance with write commands, read commands, and erase commands, respectively, from a host, and receive, from the host, time information indicating times when the write commands, read commands, and erase commands have been transmitted from or issued by the host. The memory controller is further configured to generate, from the received time information, history data including a value representing a busy state of the memory system with respect to each of a plurality of time ranges in a predetermined time period, and perform a maintenance operation with respect to the non-volatile memory upon time at which a command received from the host has been transmitted from or issued by the host falling in one or more of the time ranges corresponding to values smaller than the other of the time ranges.

Hereafter, a specific description of a memory system according to embodiments will be described, with reference to the drawings. In the following description, identical reference signs are assigned to components having approximately identical functions or configurations, and a redundant description may be omitted. Each embodiment shown hereafter presents a device or a method for embodying a technical idea of the embodiment as an example. A technical idea of an embodiment does not limit a material, a form, a structure, a disposition, or the like of a component to that described hereafter. A technical idea of an embodiment may be such that various changes are added to the scope of the claims.

In the following description, a “maintenance process” means a background process executed in a memory system. The maintenance process includes a process to access a storage area of a non-volatile memory, regardless of addresses specified by commands from a host. Maintenance processes include processes such as a garbage collection, a refresh, and a patrol read with respect to the non-volatile memory.

A garbage collection is a process for increasing usable blocks among physical blocks, to be described hereafter, and means, for example, a process of collecting valid data from a plurality of active blocks in which valid data and invalid data are included, rewriting the valid data into another block, and securing a free block. Herein, an active block is a physical block in which valid data are stored. A free block is a physical block in which no valid data are stored. After an erasure, a free block can be reused as an erased block. In the present embodiment, free blocks include both a block before erasure in which no valid data are stored, and an erased block. Valid data are data that are correlated to a logical address, to be described hereafter, and invalid data are data to which no logical address is correlated. An erased block becomes an active block when data are written therein.

A refresh is, for example, a process of rewriting data in a physical block into another physical block when a degradation of data in the physical block is detected, such as when the number of correcting bits in an error correction code decoding, to be described hereafter, increases, or the like.

A patrol read is a process of, for example, reading data stored in a non-volatile memory a predetermined unit at a time, and testing the data read based on a result of an error correction code decoding, in order to detect a physical block in which the number of errors occurring increases. This testing process is such that, for example, the number of error bits in the data read is compared with a threshold, and data wherein the number of error bits exceeds the threshold are taken to be a refresh target.

### 1. First Embodiment

A memory system according to a first embodiment will be described. The memory system according to the first embodiment includes, for example, a NAND flash memory as a semiconductor storage device, and a memory controller that controls the NAND flash memory. In the present embodiment, a memory controller has a function of determining whether to execute a maintenance process.

### 1-1. Overall Configuration of Memory System 1

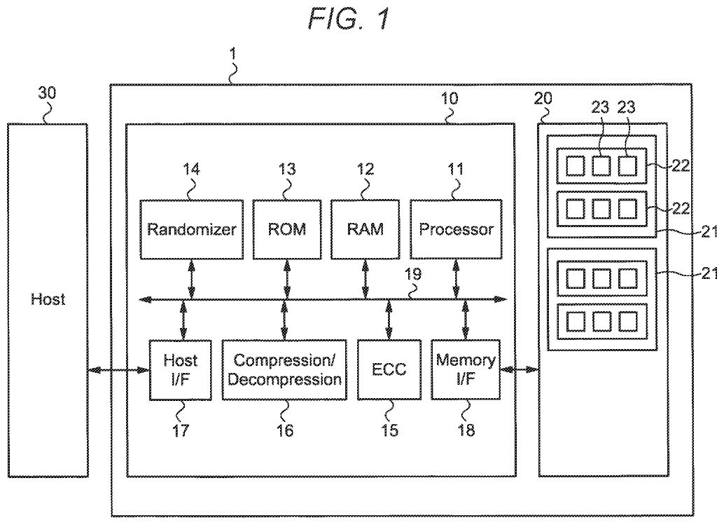

FIG. 1 is a block diagram illustrating a configuration of a memory system according to an embodiment. As shown in FIG. 1, a memory system 1 includes a memory controller 10, and a non-volatile memory 20 including a plurality of memory cells. The memory system 1 can be connected to a host 30. In FIG. 1, a state wherein the memory system 1 and the host 30 are connected is shown. The host 30 is an electronic device such as a personal computer or a mobile terminal.

The non-volatile memory 20 includes a plurality of memory chips 21. The memory controller 10 controls each of the memory chips 21. Specifically, the memory controller 10 executes an operation of writing data into each of the memory chips 21, a read operation, and an erase operation. Each of the memory chips 21 is connected to the memory controller 10 via a NAND bus.

Each memory chip 21 includes a plurality of dies 22. The die 22 refers to a wafer unit on which a plurality of memory cells is formed. The memory chip 21 is configured with the plurality of dies 22 being stacked.

A plurality of memory blocks 23 are provided in each die 22. The memory block 23 is a unit that can be erased at a time. All memory cell transistors provided in the memory block 23 are connected to the same source line. One unit of the memory block 23 may be called a “physical block”.

The memory block 23 is configured with a plurality of pages. A write operation and a read operation are executed in page units. A memory cell transistor, which is a minimum unit of a memory element, may simply be called a “memory cell”. A position of a memory cell in a physical block may be called a “physical address”.

The non-volatile memory 20 is a non-volatile memory that stores data in a non-volatile manner, for example, a NAND flash memory (hereafter simply called a NAND memory). In the following description, a case wherein a NAND memory is used as the non-volatile memory 20 is presented as an example, but a semiconductor storage device other than a NAND memory, such as a three-dimensional flash memory, a resistive random-access memory (ReRAM), or a ferroelectric random-access memory (FeRAM), may be used as the non-volatile memory 20. It is not essential that the non-volatile memory 20 is a semiconductor storage device. The present embodiment is applicable to various kinds of storage medium other than a semiconductor storage device.

The memory system 1 may be a memory card, or the like, wherein the memory controller 10 and the non-volatile memory 20 are configured as one package, or may be a solid-state drive (SSD) or the like.

The memory controller 10 is, for example, a semiconductor integrated circuit configured as a system on a chip (SoC). Although one portion or a whole of an operation of each component of the memory controller 10 described hereafter is performed using hardware, the operation may be performed by a central processing unit (CPU) executing firmware.

The memory controller 10 controls an operation of writing into the non-volatile memory 20 in accordance with a write request (write command) from the host 30, controls an operation of reading from the non-volatile memory 20 in accordance with a read request (read command) from the host 30, and controls an operation of erasing with respect to the non-volatile memory 20 in accordance with an erase request (erase command) from the host 30. The memory controller 10 includes a processor 11, a random-access memory (RAM) 12, a read-only memory (ROM) 13, a randomizer 14, an ECC circuit (ECC) 15, a compression/decompression circuit 16, a host interface (host I/F) 17, and a memory interface (memory I/F) 18. These functional blocks are connected to each other by an internal bus 19.

The processor 11 is a control unit that comprehensively controls each functional block of the memory system 1. When receiving a request (command) from the host 30 via the host interface 17, the processor 11 carries out a control that is in accordance with the command. For example, the processor 11 instructs the memory interface 18 with regard to an operation of writing data into the non-volatile memory 20 in accordance with a write command from the host 30. The processor 11 instructs the memory interface 18 with regard to an operation of reading data from the non-volatile memory 20 in accordance with a read command from the host 30. The processor 11 instructs the memory interface 18 with regard to an operation of erasing data from the non-volatile memory 20 in accordance with an erase command from the host 30.

When receiving a write command from the host 30, the processor 11 determines a storage area (memory area) in the non-volatile memory 20 for writing target data temporarily held in the RAM 12. That is, the processor 11 manages a data writing destination. A correlation between a logical address of data received from the host 30 and a physical address indicating a memory area in the non-volatile memory 20 in which the data are stored is stored in an address conversion table. When executing a write operation that accords with a write command, the processor 11 can hold a time at which the write operation is carried out, or a time from a reference time, in the RAM 12.

When receiving a read command from the host 30, the processor 11 converts a logical address specified by the read command into a physical address using the address conversion table, and instructs the memory interface 18 with regard to an operation of reading from the physical address. When executing a read operation in accordance with a read command, the processor 11 can hold a time at which the read operation is carried out, or a time from a reference time, in the RAM 12.

When receiving an erase command from the host 30, the processor 11 converts a logical address specified by the erase command into a physical address using the address conversion table, and instructs the memory interface 18 with regard to an operation of erasing with respect to the physical address. When executing an erase operation in accordance with an erase command, the processor 11 can hold a time at which the erase operation is carried out, or a time from a reference time, in the RAM 12.

In a NAND memory, generally, a write operation and a read operation are executed in data units called “pages”, and an erase is executed in data units of the “physical blocks”. In the following description, a “page” is a minimum unit of a write operation. A plurality of memory cells connected to the same word line are called a “memory cell group”. When a memory cell is a single-level cell (SLC), one page is configured with one memory cell group. When a memory cell is a multibit cell, such as a multi-level cell (MLC) wherein two pages are configured with one memory cell group, a triple-level cell (TLC) wherein three pages are configured with one memory cell group, or a quad-level cell (QLC) wherein four pages are configured with one memory cell group, one memory cell group corresponds to a plurality of pages. Each memory cell is connected to both a word line and a bit line. Consequently, each memory cell can be identified using an address that identifies a word line and an address that identifies a bit line.

The RAM 12 is used as, for example, a data buffer, and temporarily holds data received by the memory controller 10 from the host 30 until the data are stored in the non-volatile memory 20. The RAM 12 temporarily holds data read from the non-volatile memory 20 until the data are transmitted to the host 30. A general purpose memory such as a static random-access memory (SRAM) or a dynamic random-access memory (DRAM) may be used as the RAM 12.

The ROM 13 stores various kinds of program, parameter, and the like for causing the memory controller 10 to operate. A program, a parameter, or the like stored in the ROM 13 is read by the processor 11 and executed as necessary.

The randomizer 14 includes, for example, a linear feedback shift register, and generates a pseudorandom number unambiguously calculated with respect to an input seed value. A pseudorandom number generated by the randomizer 14 is, for example, a value such that an exclusive OR with respect to write data is calculated by the processor 11. Because of this, write data written into the non-volatile memory 20 are randomized. The randomizer 14 executes a reversal of randomization with respect to data read from the non-volatile memory 20. A reversal of randomization means obtaining pre-randomization original data from randomized data.

The ECC circuit 15 executes an ECC encoding (an error correction code encoding) at a time of a write operation and an ECC decoding (an error correction code decoding) at a time of a read operation, based on an instruction from the processor 11. An encoding method wherein, for example, a low-density parity-check (LDPC) encoding, a Bose-Chaudhuri-Hocquenghem (BCH) encoding, or a Reed-Solomon (RS) encoding is used may be employed as an encoding method of the ECC circuit 15.

The compression/decompression circuit 16 operates as an encoding unit that compresses data to be written into the non-volatile memory 20. The compression/decompression circuit 16 also operates as a decoding unit that decompresses data read from the non-volatile memory 20.

The host interface 17 executes a process that is in accordance with an interface standard between the host 30 and the host interface 17. The host interface 17 outputs a command received from the host 30, write target data, and the like to the internal bus 19. The host interface 17 transmits data read from the non-volatile memory 20 and decompressed by the compression/decompression circuit 16 to the host 30. The host interface 17 transmits a response or the like from the processor 11 to the host 30.

The memory interface 18 executes a write operation and an erase operation with respect to the non-volatile memory 20 based on an instruction from the processor 11. The memory interface 18 executes an operation of reading from the non-volatile memory 20 based on an instruction from the processor 11.

In the memory system 1 with the aforementioned kind of configuration, the processor 11 instructs the compression/decompression circuit 16 to compress data when executing an operation of writing into the non-volatile memory 20. When doing so, the processor 11 determines a storage location (a storage address) of the write data in the non-volatile memory 20, and notifies the memory interface 18 of the determined storage address. The compression/decompression circuit 16 compresses data in the RAM 12 based on the instruction from the processor 11. The randomizer 14 randomizes the compressed data in the RAM 12 based on an instruction from the processor 11. The ECC circuit 15 further ECC encodes the randomized data based on an instruction from the processor 11. Write data generated thereby is written into the specified storage address in the non-volatile memory 20 via the memory interface 18.

Meanwhile, at a time of a read operation with respect to the non-volatile memory 20, the processor 11 specifies an address in the non-volatile memory 20, determines memory cell read operation conditions in accordance with the specified address, and instructs the memory interface 18 to execute a read operation. The processor 11 instructs the ECC circuit 15 to start an ECC decoding, instructs the randomizer 14 to start a reversal of randomization, and instructs the compression/decompression circuit 16 to start a decompression. The memory interface 18 executes a read operation with respect to the specified address in the non-volatile memory 20 in accordance with the instruction from the processor 11, and inputs read data obtained from the read operation into the ECC circuit 15. The ECC circuit 15 ECC decodes the input read data. The randomizer 14 executes a reversal of randomization with respect to the ECC decoded data. The compression/decompression circuit 16 decompresses the data on which the reversal of randomization is executed. When the decompression succeeds, the processor 11 stores the decompressed original data in the RAM 12. Meanwhile, when the ECC decoding, the reversal of randomization, or the decompression fails, the processor 11, for example, notifies the host 30 of a read error.

### 1-2. Functional Configuration of Memory System 1 Relating to Maintenance Process

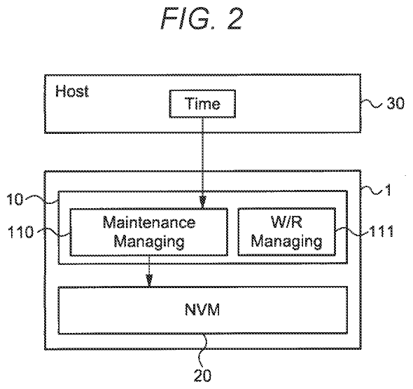

Using FIG. 2, a functional configuration relating to a maintenance process performed in the memory system 1 according to an embodiment of the disclosure will be described. FIG. 2 is a functional block diagram of a memory system according to an embodiment. As shown in FIG. 2, the memory controller 10 includes a maintenance managing unit 110 and a write/read (W/R) managing unit 111.

The maintenance managing unit 110 acquires time information (Time) from a first command received from the host 30. The time information is information indicating a time relating to a write command, a read command, or an erase command. Specifically, time information is information indicating a time at which the host 30 issues a write command, a read command, or an erase command. It should be noted that time information may also be information indicating a time at which the host 30 transmits a write command, a read command, or an erase command to the memory system 1. A time indicated by time information may be an actual time (a time including year, month, and day), or may be a time elapsed from a certain reference time. As heretofore described, a first command is a command that notifies the memory controller 10 of time information relating to a write command, a read command, or an erase command, and causes the time information to be stored. A first command is a command that differs from all of a read command, a write command, and an erase command, and is a command transmitted separately from these commands.

The maintenance managing unit 110 determines whether to execute a maintenance process of the non-volatile memory 20 (NVM) based on the time information. When it is determined that there is a need to execute a maintenance process, the maintenance managing unit 110 executes a maintenance process such as a garbage collection, a refresh, or a patrol read with respect to the non-volatile memory 20.

The W/R managing unit 111 executes a write operation, a read operation, and an erase operation with respect to the non-volatile memory 20 in accordance with a write command, a read command, and an erase command respectively. When receiving a write command, a read command, or an erase command, the W/R managing unit 111 notifies the maintenance managing unit 110 of the reception of the command. In accordance with the notification, the maintenance managing unit 110 requests a first command from the host 30. Alternatively, instead of the W/R managing unit 111 notifying the maintenance managing unit 110 of the reception of a command, the host 30 may spontaneously notify the maintenance managing unit 110 of the first command. For example, the host 30 may notify the maintenance managing unit 110 of the first command regularly (for example, every 30 minutes).

The maintenance managing unit 110 acquires the time information by performing the aforementioned operation. The maintenance managing unit 110 counts the number of target commands received from the host 30 based on the acquired time information. For example, when the counting target is a write command, the maintenance managing unit 110 increments the write command count based on time information received from the host 30. The maintenance managing unit 110 can generate a histogram configured with a command count in each period based on time information and a command count. This histogram is an example of history data. A detailed histogram generation method will be described hereafter.

A count incremented by the maintenance managing unit 110 may differ in accordance with details of a process executed in accordance with a command. That is, the maintenance managing unit 110 may apply a weighting when incrementing a command count. For example, when time needed for a write operation is longer than time needed for a read operation, the number by which the write command count is incremented can be greater than the number by which the read command count or the erase command count is incremented. In other words, a weight ratio of a write command count with respect to a write command may differ from a weight ratio of a read command count with respect to a read command or a weight ratio of an erase command count with respect to an erase command, and a weight ratio relating to a write command count may be greater than a weight ratio relating to a read command count or an erase command count.

### 1-3. Histogram Generation Flowchart

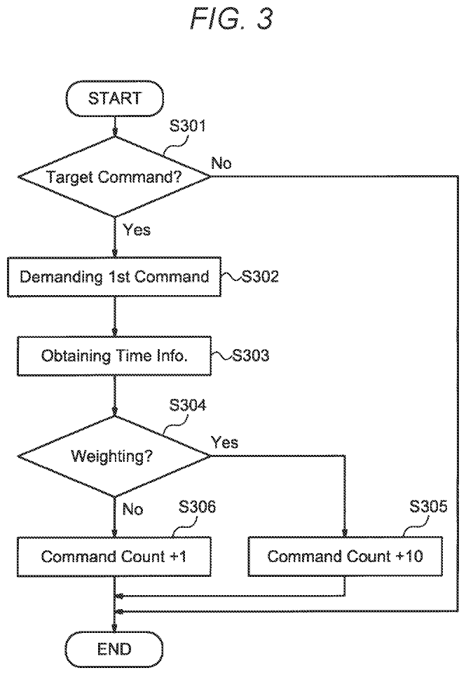

A histogram generation method will be described, using FIG. 3. FIG. 3 is a flowchart relating to histogram generation in a memory system according to an embodiment. On receiving a command from the host 30, the memory controller 10 starts a histogram generation operation in accordance with the flowchart shown in FIG. 3.

First, in step S301 (Target Command?), it is determined whether a command received by the memory controller 10 from the host 30 is a counting target command. When a command received from the host 30 is a counting target command (“Yes” in step S301), the maintenance managing unit 110 requests a first command from the host 30 (step S302: Demanding 1st Command). Meanwhile, when a command received from the host 30 is not a counting target command (“No” in step S301), the series of operations in FIG. 3 ends.

When a command received from the host 30 is a write command or an erase command, the W/R managing unit 111 executes a write operation or an erase operation with respect to the non-volatile memory 20. When a command received from the host 30 is a read command, the W/R managing unit 111 executes a read operation with respect to the non-volatile memory 20. The operation of S301 may be executed simultaneously with a write operation, a read operation, or an erase operation, or may be executed after these operations.

A first command is transmitted from the host 30 to the memory controller 10 in response to the first command request in S302. As heretofore described, time information is included in the first command. The memory controller 10 acquires time information from the first command received from the host 30 (step S303: Obtaining Time Info.).

After acquiring the time information, the maintenance managing unit 110 determines whether to apply weighting when counting commands (step S304: Weighting?). When a command received from the host 30 is a target of weighting application (“Yes” in S304), the command count is incremented by, for example, “+10” (step S305: Command Count+10). Meanwhile, when a command received from the host 30 is not a target of weighting application (“No” in S304), the command count is incremented by, for example, “+1” (step S306: Command Count+1). The numbers of increments in S305 and S306 are freely selected, and are not limited to the aforementioned values.

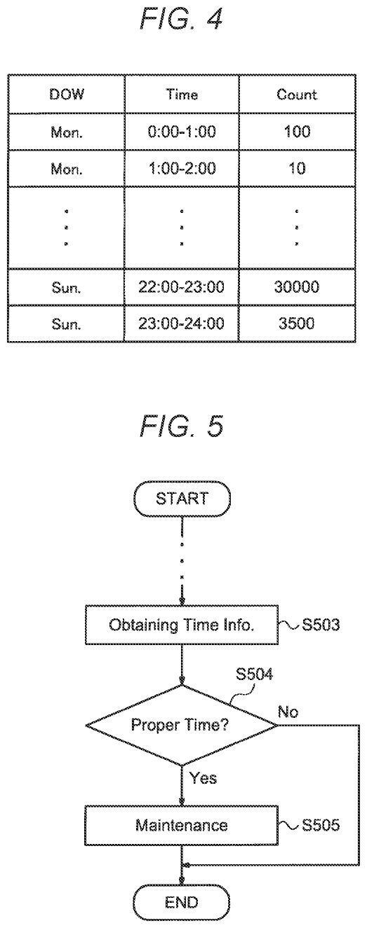

The command counts of S305 and S306 are managed in each preset period based on the time information acquired in S303. A set period may be a period such that one day is divided into one hour sections, or may be a period such that one week is divided into one hour sections. When one day is divided into one hour sections, 24 periods are set as in, for example, 0:00 to 1:00, 1:00 to 2:00, and so on to 22:00 to 23:00, and 23:00 to 24:00. When one week is divided into one hour sections, 168 (24 (hours: Time)×7 (days: DOW)) periods are set as in, for example, Monday (Mon.) 0:00 to 1:00, Monday 1:00 to 2:00, and so on to Sunday (Sun.) 22:00 to 23:00, and Sunday 23:00 to 24:00 (refer to FIG. 4). The aforementioned command counts are accumulated in each aforementioned period. The command count in each aforementioned period is stored in the non-volatile memory 20. A histogram is constructed by the heretofore described process being repeated for one week or one month.

When there is no need for weighting depending on commands received from the host 30, steps S304 and S305 are omitted, and step S306 may be carried out after step S303.

### 1-4. Histogram Example

Using FIG. 4, a configuration of a histogram will be described. FIG. 4 is a drawing showing an example of a histogram used in a memory system according to an embodiment. The histogram shown in FIG. 4 is a histogram in a case wherein one week is divided into one hour sections, as heretofore described. As heretofore described, a command count is accumulated and managed in each set period. As a result of this, in the example of FIG. 4, the count for Monday 0:00 to 1:00 is 100 times, the count for Monday 1:00 to 2:00 is 10 times, the count for Sunday 22:00 to 23:00 is 30,000 times, and the count for Sunday 23:00 to 24:00 is 3,500 times. In FIG. 4, a list is displayed, and although the list is not in graph form, the list is expressed as a histogram.

### 1-5. Maintenance Process Execution Flowchart

Using FIG. 5, a maintenance process execution method will be described. FIG. 5 is a flowchart relating to a maintenance process performed in a memory system according to an embodiment. On receiving a command from the host 30, the memory controller 10 starts an operation to determine whether to perform a maintenance process in accordance with the flowchart shown in FIG. 5. As steps from the start of the flowchart of FIG. 5 until step S503, in which time information is acquired, are the same as the steps from the start of the flowchart of FIG. 3 until S303, an illustration and a description thereof will be omitted.

After acquiring time information in S503, the maintenance managing unit 110 determines whether the time indicated by the acquired time information is appropriate as a time at which a maintenance process is executed (step S504: Proper Time?). Specifically, the maintenance managing unit 110 refers to the histogram shown in FIG. 4, and carries out the determination of S504 based on the count at the time of the time information acquired in S503.

For example, when the period to which the time of the time information acquired in S503 belongs is the period in the histogram shown in FIG. 4 in which the count is the lowest, the maintenance managing unit 110 determines that the period is appropriate as a period in which a maintenance process is executed. When the aforementioned configuration is reworded by replacing “the period in the histogram in which the count is the lowest” with “a maintenance process execution period”, the maintenance managing unit 110 selects one maintenance process execution period based on the command count in each period, and executes a maintenance process in that period.

When arranging the periods in the histogram shown in FIG. 4 in order of lowest count, the period to which the time of the time information acquired in S503 belongs may be determined to be appropriate as a maintenance process execution period when the period is included in, for example, the top 10% of periods.

When it is determined that the time of the time information acquired in S503 is appropriate (“Yes” in S504), a maintenance process is executed (step S505: Maintenance). Meanwhile, when it is determined that the time is not appropriate (“No” in S504), the flowchart shown in FIG. 5 ends without the maintenance process being executed.

According to the memory system 1 according to the present embodiment, as heretofore described, a maintenance process can be executed in a period in which a command count is low. A period in which a command count is low corresponds to a period in which a user less frequently uses a device relating to the host 30 (i.e., a period in which the memory system 1 is in a less busy state). Consequently, a maintenance process can be executed in such a period in which the memory system 1 is less frequently accessed, and as a result a performance of the memory system 1 is less likely affected by the maintenance process.

### 2. Second Embodiment

A memory system according to a second embodiment will be described. The memory system 1 according to the second embodiment differs from the memory system 1 according to the first embodiment in terms of a functional configuration and a histogram generation flowchart. As the rest of the configurations are the same as the configurations of the first embodiment, a description thereof will be omitted.

### 2-1. Functional Configuration of Memory System 1 Relating to Maintenance Process

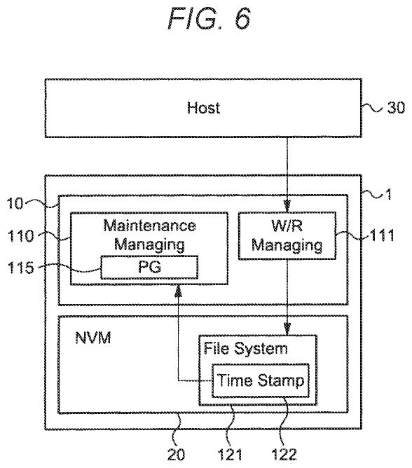

Using FIG. 6, a functional configuration relating to a maintenance process performed by the memory system 1 according to an embodiment of the disclosure will be described. FIG. 6 is a functional block diagram of a memory system according to an embodiment. The functional block diagram shown in FIG. 6 is similar to the functional block diagram shown in FIG. 2, but differs from the functional block diagram shown in FIG. 2 in terms of a method of acquiring time information.

In the present embodiment, rather than time information being acquired from a first command, time information is acquired by the maintenance managing unit 110 of the memory controller 10 analyzing a file system 121. The file system 121 is a data structure to manage data stored in the non-volatile memory 20 and an address at which the data are stored, and includes metadata (for example, a time stamp 122) including a time at which the data are stored in the non-volatile memory 20, and the like. For example, in the case of “File System FAT32”, a time at which a file is newly generated and a time at which the file is updated are included in the file system 121. Specifically, “0×10 Create date” and “0×18 Last Modified Date” are defined as the time stamp 122 in a “Directory entry” area of the file system 121, and these correspond to the aforementioned generation time and update time respectively.

The maintenance managing unit 110 identifies the time stamp 122 included in the file system 121 in accordance with the type of the file system, and reads the identified time stamp 122 as the time information. As an area in which the time stamp 122 exists differs in accordance with the type of the file system, the maintenance managing unit 110 executes a program 115 (PG) that analyzes the data structure of the file system, and determines whether the data include the time stamp 122. Specifically, the program 115 can analyze a representative plurality of file systems.

### 2-2. Histogram Generation Flowchart

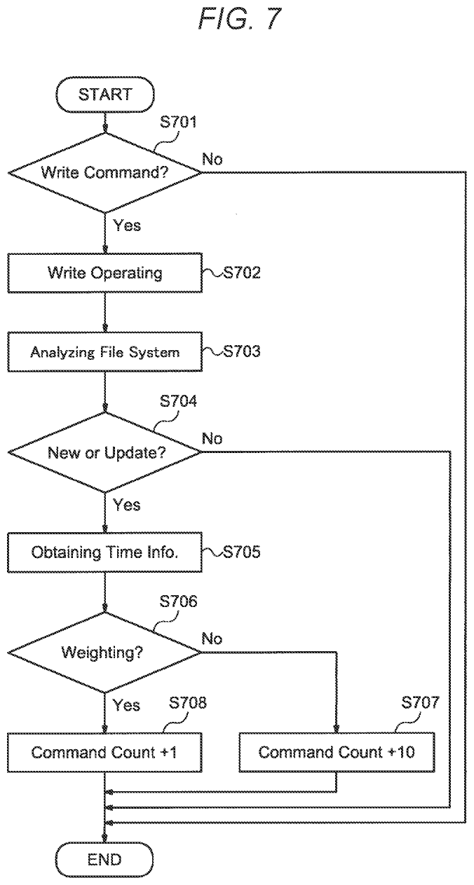

A histogram generation method will be described, using FIG. 7. FIG. 7 is a flowchart relating to histogram generation in a memory system according to an embodiment. On receiving a command from the host 30, the memory controller 10 starts a histogram generation operation in accordance with the flowchart shown in FIG. 7.

First, in step S701 (Write Command?), it is determined whether a command received by the memory controller 10 from the host 30 is a write command. When a command received from the host 30 is a write command (“Yes” in step S701), the W/R managing unit 111 executes a write operation with respect to the non-volatile memory 20 (step S702: Write Operating). Meanwhile, when a command received from the host 30 is not a write command (“No” in step S701), the series of operations in FIG. 7 ends.

When the write operation of S702 is completed, the maintenance managing unit 110 analyzes the file system 121 relating to the data written (step S703: Analyzing File System), and reads the time stamp 122. Continuing, the maintenance managing unit 110 determines whether the read time stamp 122 indicates a newly recorded time or indicates an updated time (step S704: New or Update?).

When it is determined that the time stamp 122 indicates a new recording or indicates an updated time (“Yes” in S704), the maintenance managing unit 110 acquires the time stamp 122 as the time information (step S705: Obtaining Time Info). Meanwhile, when it is determined that the time stamp 122 does not indicate a new recording, and does not indicate an updated time (“No” in S704), the series of operations in FIG. 7 ends. As steps S706 to S708 are the same as steps S304 to S306 of FIG. 3, a description thereof will be omitted.

In the present embodiment, the process of the maintenance managing unit 110 acquiring the time information may be executed every time a write command is received, or may be executed every certain multiple of times a write command is received.

### 2-3. Maintenance Process Execution Flowchart

As a maintenance process execution flowchart in the present embodiment is the same as that in FIG. 5, a description thereof will be omitted. In the case of the present embodiment, the steps from the start of the flowchart of FIG. 5 until step S503, in which time information is acquired, are the same as the steps from the start of the flowchart of FIG. 7 until S705.

According to the memory system 1 according to the present embodiment, as heretofore described, the time information can be acquired in the same way as in the first embodiment, without the memory controller 10 requesting the first command from the host 30.

### 3. Third Embodiment

A memory system according to a third embodiment will be described. The memory system 1 according to the third embodiment differs from the memory system 1 according to the first embodiment in terms of a functional configuration and a histogram generation flowchart. As the rest of the configurations are the same as the configurations of the first embodiment, a description thereof will be omitted.

### 3-1. Functional Configuration of Memory System 1 Relating to Maintenance Process

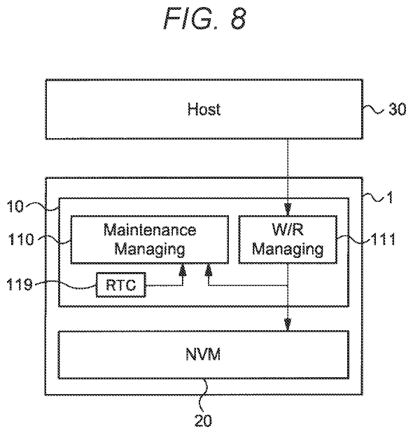

Using FIG. 8, a functional configuration relating to a maintenance process performed by the memory system 1 according to an embodiment of the disclosure will be described. FIG. 8 is a functional block diagram of a memory system according to an embodiment. The functional block diagram shown in FIG. 8 is similar to the functional block diagram shown in FIG. 2, but differs from the functional block diagram shown in FIG. 2 in terms of a method of acquiring time information.

In the present embodiment, rather than the time information being acquired from the first command, the time information is acquired using a clock function (e.g., a real time clock (RTC) circuit 119) included in the non-volatile memory 20 (the memory controller 10). As shown in FIG. 8, the W/R managing unit 111 executes a write operation, a read operation, or an erase operation in accordance with a write command, a read command, or an erase command, respectively, and notifies the maintenance managing unit 110 of the execution of these operations. On receiving the notification, the maintenance managing unit 110 reads the time at which the notification is received from the RTC 119. By performing the aforementioned operation, the maintenance managing unit 110 acquires time information indicating a time at which the W/R managing unit 111 executes a write operation, a read operation, or an erase operation. As long as the time information is information indicating a time relating to a write operation, a read operation, or an erase operation, the time information is not limited to information indicating a time at which these operations are executed. The time information may be information indicating a time at which a write command, a read command, or an erase command is received from the host 30.

### 3-2. Histogram Generation Flowchart

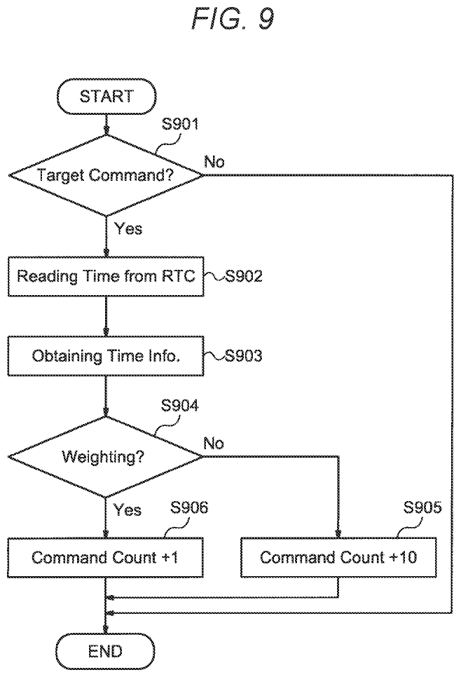

A histogram generation method will be described, using FIG. 9. FIG. 9 is a flowchart relating to histogram generation in a memory system according to an embodiment. On receiving a command (a second command) from the host 30, the memory controller 10 starts a histogram generation operation in accordance with the flowchart shown in FIG. 9.

First, in step S901 (Target Command?), it is determined whether a command received by the memory controller 10 from the host 30 is a counting target command. When a second command received from the host 30 is a counting target command (“Yes” in step S901), the maintenance managing unit 110 reads a time at which the second command is received from the host 30, or a time at which the non-volatile memory 20 is accessed in accordance with the second command, from the RTC 119 (step S902: Reading Time from RTC), thereby acquiring time information (step S903: Obtaining Time Info). That is, the maintenance managing unit 110 acquires time information indicating a time at which a second command is received or a time at which an operation based on a second command is executed. Meanwhile, when a second command received from the host 30 is not a counting target command (“No” in step S901), the series of operations in FIG. 9 ends. As steps S904 to S906 are the same as steps S304 to S306 of FIG. 3, a description thereof will be omitted.

### 3-3. Maintenance Process Execution Flowchart

As a maintenance process execution flowchart in the present embodiment is the same as that in FIG. 5, a description thereof will be omitted. In the case of the present embodiment, the steps from the start of the flowchart of FIG. 5 until step S503, in which time information is acquired, are the same as the steps from the start of the flowchart of FIG. 9 until S903.

According to the memory system 1 according to the present embodiment, as heretofore described, the time information can be acquired in the same way as in the first embodiment, without the memory controller 10 requesting the first command from the host 30.

### 4. Fourth Embodiment

A memory system according to a fourth embodiment will be described. The memory system 1 according to the fourth embodiment differs from the memory system 1 according to the first embodiment in terms of a maintenance process execution flowchart. As the rest of the configurations are the same as the configurations of the first embodiment, a description thereof will be omitted.

### 4-1. Maintenance Process Execution Flowchart

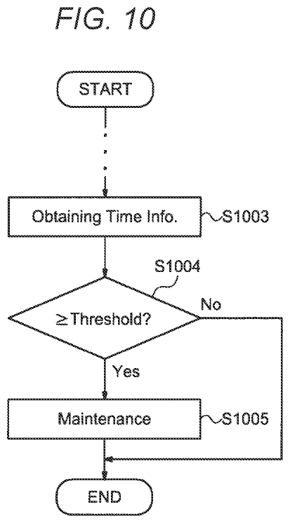

Using FIG. 10, a maintenance process execution method will be described. FIG. 10 is a flowchart relating to a maintenance process performed in a memory system according to an embodiment. On receiving a command from the host 30, the memory controller 10 starts a maintenance process in accordance with the flowchart shown in FIG. 10. As steps from the start of the flowchart of FIG. 10 until step S1003, in which time information is acquired, are the same as the steps from the start of the flowchart of FIG. 3 until S303, the steps from the start of the flowchart of FIG. 7 until S705, and the steps from the start of the flowchart of FIG. 9 until S903, an illustration and a description thereof will be omitted.

After acquiring time information in S1003, the maintenance managing unit 110 calculates a difference between a point at which time information was acquired the previous time and a point at which time information was acquired this time, and determines whether the difference is equal to or greater than a threshold (step S1004: Threshold?). When the difference is equal to or greater than the threshold (“Yes” in S1004), a maintenance process is executed (step S1005: Maintenance). Meanwhile, when the difference is smaller than the threshold (“No” in S1004), the flowchart shown in FIG. 10 ends without a maintenance process being executed. That is, the maintenance managing unit 110 determines whether to execute a maintenance process based on the difference and a threshold.

According to the memory system 1 according to the present embodiment, as heretofore described, an advantage the same as that in the first embodiment can be obtained.

In the heretofore described embodiments, whether to execute the maintenance process is determined based on the determination of whether a condition is satisfied, but this configuration is not limiting. For example, a larger amount of maintenance processes may be executed when a condition is met compared with when the condition is not met.

While certain embodiments have been described, these embodiments have been presented by way of example only, and are not intended to limit the scope of the disclosure. Indeed, the novel embodiments described herein may be embodied in a variety of other forms; furthermore, various omissions, substitutions, and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A memory system comprising:
a non-volatile memory; and
a memory controller configured to:
perform write operations, read operations, and erase operations with respect to the non-volatile memory in accordance with write commands, read commands, and erase commands, respectively, from a host;
receive, from the host, time information indicating times when the write commands, read commands, and erase commands have been transmitted from or issued by the host;
generate, from the received time information, history data including a value representing a busy state of the memory system with respect to each of a plurality of time ranges in a predetermined time period; and
perform a maintenance operation with respect to the non-volatile memory upon time at which a command received from the host has been transmitted from or issued by the host falling in one or more of the time ranges corresponding to values smaller than the other of the time ranges.

2. The memory system according to claim 1, wherein the memory controller is configured to transmit, to the host, a request for the time information with respect to each of the write commands, each of the read commands, and each of the erase commands received from the host.

3. The memory system according to claim 1, wherein the memory controller receives the time information regularly from the host, without requests to the host.

4. The memory system according to claim 1, wherein the value representing the busy state of the memory system is obtained based on a sum of a first count value representing the number of write commands that have been transmitted from or issued by the host within the corresponding time range, a second count value representing the number of read commands that have been transmitted from or issued by the host within the corresponding time range, and a third count value representing the number of erase commands that have been transmitted from or issued by the host within the corresponding time range.

5. The memory system according to claim 4, wherein
the first count value is weighted by a first weight ratio, the second count value is weighted by a second weight ratio, and the third count value is weighted by a third weight ratio,
the first weight ratio being different from the second weight ratio and the third weight ratio.

6. The memory system according to claim 5, wherein
the first weight ratio is greater than the second weight ratio and the third weight ratio, and
the second weight ratio is equal to the third weight ratio.

7. The memory system according to claim 1, wherein the predetermined period is a day, a week, or a month.

8. The memory system according to claim 1, wherein the maintenance operation includes a garbage collection with respect to the non-volatile memory.

9. The memory system according to claim 1, wherein the maintenance operation includes a refresh operation with respect to the non-volatile memory.

10. A memory system comprising:
a non-volatile memory; and
a memory controller configured to:
perform write operations with respect to the non-volatile memory in accordance with write commands from a host;
obtain, within the memory system, time information indicating times when the write operations have been performed with respect to the non-volatile memory;
generate, from the obtained time information, history data including a value representing a busy state of the memory system with respect to each of a plurality of time ranges in a predetermined time period; and
perform a maintenance operation with respect to the non-volatile memory upon time at which an operation instructed by a command from the host has been performed with respect to the non-volatile memory falling in one or more of the time ranges corresponding to values smaller than the other of the time ranges.

11. The memory system according to claim 10, wherein the memory controller is configured to obtain the time information from a file system stored in the non-volatile memory.

12. The memory system according to claim 11, wherein the time information obtained from the file system stored in the non-volatile memory includes a time stamp indicating time when data has been written into the non-volatile memory.

13. The memory system according to claim 11, wherein the predetermined period is a day, a week, or a month.

14. The memory system according to claim 11, wherein the maintenance operation includes a garbage collection with respect to the non-volatile memory.

15. The memory system according to claim 1, wherein the maintenance operation includes a refresh operation with respect to the non-volatile memory.

16. A memory system comprising:
a non-volatile memory;
a clock circuit; and
a memory controller configured to:
perform write operations, read operations, and erase operations with respect to the non-volatile memory in accordance with write commands, read commands, and erase commands, respectively, from a host;
obtain, from the clock circuit, time information indicating times when the write operations, read operations, and erase operations have been performed with respect to the non-volatile memory;
generate, from the received time information, history data including a value representing a busy state of the memory system with respect to each of a plurality of time ranges in a predetermined time period; and
perform a maintenance operation with respect to the non-volatile memory upon time at which an operation instructed by a command from the host has been performed with respect to the non-volatile memory falling in one or more of the time ranges corresponding to values smaller than the other of the time ranges.

17. The memory system according to claim 16, wherein the clock circuit is included in the memory controller.

18. The memory system according to claim 16, wherein the value representing the busy state of the memory system is obtained based on a sum of a first count value representing the number of write commands that have been transmitted from or issued by the host within the corresponding time range, a second count value representing the number of read commands that have been transmitted from or issued by the host within the corresponding time range, and a third count value representing the number of erase commands that have been transmitted from or issued by the host within the corresponding time range.

19. The memory system according to claim 18, wherein
the first count value is weighted by a first weight ratio, the second count value is weighted by a second weight ratio, and the third count value is weighted by a third weight ratio,
the first weight ratio being different from the second weight ratio and the third weight ratio.

20. The memory system according to claim 19, wherein
the first weight ratio is greater than the second weight ratio and the third weight ratio, and
the second weight ratio is equal to the third weight ratio.
